(19) United States
(12) Patent Application Publication
(10) Pub. No.: US 2026/0208235 A1
(43) Pub. Date: Jul. 23, 2026

(54) Gun Barrel and Cleaning Device

(71) Applicant: Yongkang Taijun Industry and Trade Co., Ltd, Zhejiang (CN)

(72) Inventor: Changchong WANG, Shaanxi (CN)

(73) Assignee: Yongkang Taijun Industry and Trade Co., Ltd, Zhejiang (CN)

(21) Appl. No.: 19/560,087

(22) Filed: Mar. 8, 2026

(30) Foreign Application Priority Data
Jan. 21, 2025 (CN) 2025201436257

(51) Int. Cl. B08B 3/02

(52) U.S. Cl. CPC B08B 3/026; B08B 2203/02

(57) ABSTRACT

The present disclosure discloses a gun barrel and a cleaning device, wherein the gun barrel comprises a first tube body, a second tube body, a connector, a snap-fit element, and an unlocking element; one end of the first tube body along its length direction is a connecting end; the outer diameter of the second tube body is smaller than the inner diameter of the first tube body, the second tube body is sealingly inserted into the first tube from the connecting end, the outer wall surface of the second tube body is provided with a plurality of snap-fit structures arranged at intervals along the length direction of the second tube body.

### CROSS-REFERENCE TO RELATED APPLICATIONS

This application claims priority to Chinese Patent Application No. 2025201436257, filed on Jan. 21, 2025, entitled “Gun Barrel and Cleaning Device,” the content of which, including the amendments thereof, is incorporated herein by reference in its entirety.

### TECHNICAL FIELD

The present disclosure relates to the technical field of cleaning devices, and in particular, to a gun barrel and a cleaning device.

### BACKGROUND

Cleaning devices, such as high-pressure water guns, are equipment that use a gun barrel to guide high-pressure water flow for stable ejection to perform cleaning, rinsing, and other operations. In related technologies, the gun barrel is a telescopic structure with adjustable length, composed of a plurality of tube bodies sequentially inserted and connected. Adjacent tube bodies are connected by a connection assembly, which secures the two tube bodies through a compression fixation method. After releasing the tube bodies from the connection assembly, the length of the gun barrel can be adjusted by changing the insertion depth of the tube bodies. However, with this fixation method relying on compression force, the tube bodies are prone to loosening under the action of high-pressure water flow, resulting in poor structural stability of the gun barrel during operation.

### SUMMARY

The present disclosure provides a gun barrel and a cleaning device to address the issues raised in the background art, namely that with this fixation method relying on compression force, the tube bodies are prone to loosening under high-pressure water flow, leading to poor structural stability of the gun barrel during operation.

To achieve the above object, the present disclosure adopts the following technical solutions:

In a first aspect, the present disclosure provides a gun barrel, including: a first tube body, a second tube body, a connector, a snap-fit element and an unlocking element;
wherein one end of the first tube body along a length direction thereof is a connecting end;
an outer diameter of the second tube body is smaller than an inner diameter of the first tube body, the second tube body is sealingly inserted into the first tube from the connecting end, an outer wall surface of the second tube body is provided with a plurality of snap-fit structures that are arranged at intervals along a length direction of the second tube body;
the connector is connected to the connecting end;
the snap-fit element is connected to the connector;
the unlocking element is connected to the connector and separably contacts the snap-fit element, allowing the snap-fit element to be locked onto one of the snap-fit structures; and
when the unlocking element is separated from the snap-fit element, the snap-fit element is allowed to disengage from a locked state with the snap-fit structure, and the second tube body is allowed to move along the length direction thereof.

In another aspect, the present disclosure provides a gun barrel, including: a first tube body, a second tube body, a connector, a snap-fit element and an unlocking element;
wherein one end of the first tube body along a length direction thereof is a connecting end;
the second tube body is sealingly inserted into the first tube from the connecting end;
the connector is connected to the connecting end;
the snap-fit element is connected to the connector; and
the unlocking element is connected to the connector and separably contacts the snap-fit element, allowing the second tube body to move along a length direction thereof.

In still another aspect, the present disclosure provides a cleaning device, including: a gun barrel, wherein the gun barrel includes a first tube body, a second tube body, a connector, a snap-fit element and an unlocking element;
one end of the first tube body along a length direction thereof is a connecting end;
an outer wall surface of the second tube body is provided with a snap-fit structure;
one end of the connector along a length direction thereof is fixedly connected to the connecting end;
the snap-fit element is arranged on the unlocking element; and
the unlocking element is sleeved on an outer periphery of the connector.

The beneficial effects of the present disclosure compared to the prior art are as follows:

The gun barrel, the connector, the snap-fit element and the unlocking element cooperate to form a connection assembly. The connection assembly is connected to the first tube body and the second tube body through the snap-fit element engaging with the snap-fit structure. Compared to a compression connection, the connection stability between the first tube body and the second tube body is higher. When the gun barrel is applied in a high-pressure water gun, the first tube body and the second tube body are less likely to loosen under the action of high-pressure water flow, and the structural stability of the gun barrel is relatively good; when the gun barrel length needs adjustment, the unlocking element is separated from the snap-fit element to release the snap-fit element from the locked state with the snap-fit structure. Thereby, the second tube body can move along its length direction. By engaging the snap-fit element with other snap-fit structures on the second tube body, the gun barrel can be adjusted to a suitable length. Thereafter, restoring the unlocking element to contact with the snap-fit element allows the snap-fit element to lock onto that snap-fit structure, thereby stably connecting the first tube body and the second tube body. That is, based on the connection assembly formed by the cooperation of the connector, snap-fit element, and unlocking element, the gun barrel can be adjusted in length and has relatively good structural stability.

### BRIEF DESCRIPTION OF DRAWINGS

The drawings, which form part of this application, are used to provide further understanding of the present disclosure. Schematic embodiments of the present disclosure and descriptions thereof are used to explain the present disclosure and do not constitute an improper limitation of the present disclosure. In the drawings:

FIG. 1 is a structural diagram of a gun barrel according to an embodiment of the present disclosure.

FIG. 2 is a structural diagram of a second tube body according to an embodiment of the present disclosure.

FIG. 3 is an exploded schematic diagram showing the cooperation of a first tube body, a connector, a snap-fit element, an unlocking element and an elastic element according to an embodiment of the present disclosure.

FIG. 4 is a structural diagram of an unlocking element according to an embodiment of the present disclosure.

FIG. 5 is a structural diagram showing the cooperation of a valve, joint, and filter screen according to an embodiment of the present disclosure.

FIG. 6 is a structural diagram showing the disassembly of a second tube body and a connector according to the present disclosure.

Reference signs: First Tube Body (1); Second Tube Body (2); Snap-Fit Structure (201); Connector (3); Accommodating Through Hole (301); Annular Protrusion (31); Snap-Fit Element (4); Unlocking Element (5); First Annular Protrusion (51); Elastic Element (6); Valve (7); Joint (8); Filter Screen (9); Nozzle (10); Rib (11); Vertical Groove (12); Sealing Gasket (13).

### DESCRIPTION OF EMBODIMENTS

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of them. The following description of at least one exemplary embodiment is illustrative only and is in no way intended to limit the present disclosure and its applications or uses. Based on the embodiments of the present disclosure, all other embodiments obtained by those of ordinary skill in the art without creative efforts shall fall within the scope of protection of the present disclosure.

It should be noted that the terms used herein are only for describing specific embodiments and are not intended to limit the exemplary embodiments according to the present application. As used herein, unless the context clearly indicates otherwise, the singular forms are intended to include the plural forms as well. Furthermore, it should be understood that when the terms “comprise” and/or “include” are used in this specification, they indicate the presence of features, steps, operations, devices, components, and/or combinations thereof.

Unless specifically stated otherwise, the relative arrangement, numerical expressions, and numerical values of components and steps set forth in these embodiments do not limit the scope of the present disclosure. At the same time, it should be understood that for ease of description, the dimensions of the various parts shown in the drawings are not drawn according to actual proportional relationships. Techniques, methods, and equipment known to those of ordinary skill in the relevant art may not be discussed in detail, but where appropriate, such techniques, methods, and equipment should be considered as part of the authorized specification. In all examples shown and discussed herein, any specific values should be construed as illustrative only and not as limiting. Therefore, other examples of the exemplary embodiments may have different values. It should be noted that similar reference numerals and letters denote similar items in the following drawings, so once an item is defined in one drawing, it does not need to be further discussed in subsequent drawings.

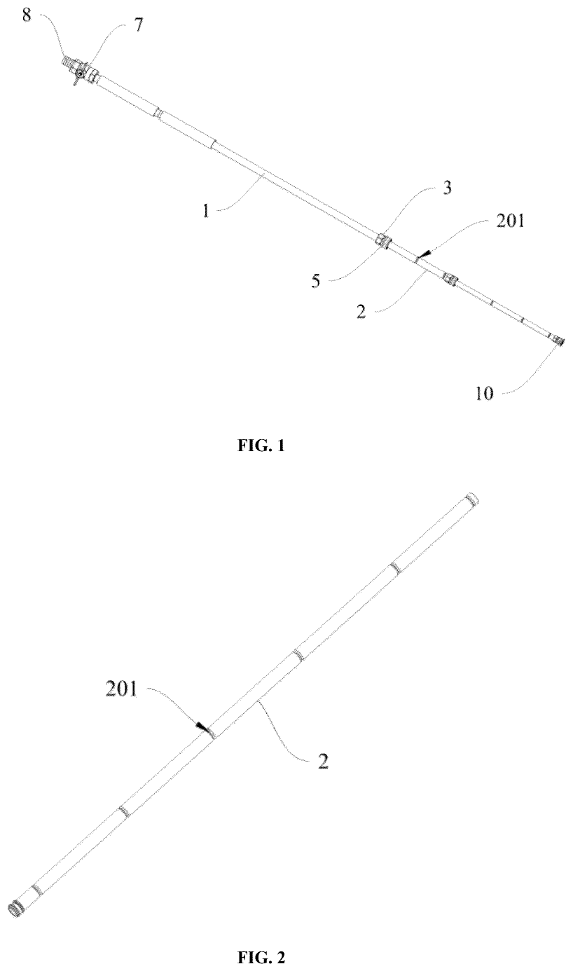

Please refer to FIGS. 1 to 5:

The present disclosure proposes a cleaning device, which includes the gun barrel described below. The cleaning device outputs cleaning media through the following gun barrel to perform cleaning operations. The cleaning device, such as a high-pressure water gun, guides a stable high-pressure water jet through the following gun barrel for cleaning, rinsing, and other operations.

As shown in FIGS. 1 to 5, a gun barrel according to an embodiment of the present disclosure includes a first tube body 1, a second tube body 2, a connector 3, a snap-fit element 4, and an unlocking element 5; one end of the first tube body 1 along its length direction is a connecting end; the outer diameter of the second tube body 2 is smaller than the inner diameter of the first tube body 1, the second tube body 2 is sealingly inserted from the connecting end into the first tube body 1, the outer wall surface of the second tube body 2 is provided with a snap-fit structure 201, the number of snap-fit structures 201 is multiple, and the plurality of snap-fit structures 201 are arranged at intervals along the length direction of the second tube body 2; the connector 3 is connected to the connecting end; the snap-fit element 4 is connected to the connector 3; the unlocking element 5 is connected to the connector 3 and is separably in contact with the snap-fit element 4, so that the snap-fit element 4 is locked onto one of the snap-fit structures 201; when the unlocking element 5 is separated from the snap-fit element 4, the snap-fit element 4 can be disengaged from the locked state with the snap-fit structure 201, and the second tube body 2 can move along its length direction.

Specifically, the connector 3, snap-fit element 4, and unlocking element 5 cooperate to form a connection assembly. This assembly is connected to the first tube body 1 and the second tube body 2 via the snap-fit element 4 engaging with the snap-fit structure 201. Compared to compression connections, the connection between the first tube body 1 and the second tube body 2 is more stable. When the gun barrel is used in a high-pressure water gun, the first tube body 1 and the second tube body 2 are less prone to loosening under high-pressure water flow, resulting in relatively better structural stability of the gun barrel. When adjusting the length of the gun barrel, the unlocking element 5 is separated from the snap-fit element 4 to release the locked state between the snap-fit element 4 and the snap-fit structure 201. Consequently, the second tube body 2 can move along its length direction. By engaging the snap-fit element 4 with other snap-fit structures 201 on the second tube body 2, the gun barrel can be adjusted to a suitable length. Thereafter, restoring the unlocking element 5 to contact with the snap-fit element 4 allows the snap-fit element 4 to lock onto that snap-fit structure 201, thereby stabilizing the connection between the first tube body 1 and the second tube body 2. That is, based on the connection assembly formed by the cooperation of the connector 3, snap-fit element 4, and unlocking element 5, the gun barrel can be adjusted in length while maintaining relatively good structural stability.

In this embodiment, as shown in FIG. 2, the snap-fit structure 201 is a snap-fit groove. The snap-fit groove is annular and arranged around the axis of the second tube body 2. The engagement between the snap-fit groove and the snap-fit element 4 provides stable axial (along the length direction of the second tube body 2) constraint. When subjected to certain pressure, tension, and vibration, the first tube body 1 and the second tube body 2 can still maintain their connected state, making them less prone to separation and resulting in relatively better structural stability of the gun barrel.

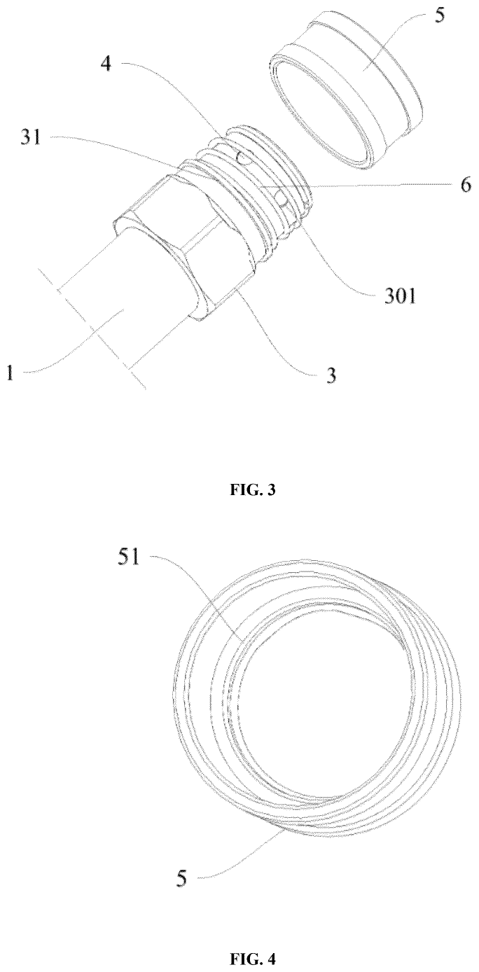

In this embodiment, as shown in FIGS. 3 and 4, the snap-fit element 4 is spherical, and there are a plurality of snap-fit elements 4; the connector 3 is cylindrical, one end of the connector 3 along its length direction is fixedly connected to the connecting end, the connector 3 is provided with accommodating through holes 301, there are a plurality of accommodating through holes 301 that are arranged around the axis of the connector 3, and each accommodating through hole 301 is movably connected with a snap-fit element 4; the unlocking element 5 is cylindrical, the unlocking element 5 is sleeved on the outer periphery of the connector 3, the inner wall surface of the unlocking element 5 has a first annular protrusion 51, the first annular protrusion 51 is arranged around the axis of the unlocking element 5, the side of the first annular protrusion 51 facing the connector 3 contacts all snap-fit elements 4, so that the snap-fit elements 4 are locked in the snap-fit groove; the gun barrel further includes an elastic element 6, the elastic element 6 is connected to the unlocking element 5 and the connector 3, so that the first annular protrusion 51 maintains contact with the snap-fit elements 4; under an external force, the unlocking element 5 can move along its length direction, and when the unlocking element 5 moves a preset distance, the first annular protrusion 51 separates from the snap-fit elements 4, and the snap-fit elements 4 is allowed to move to disengaged from a locked state with the snap-fit groove; in practical applications, when the length of the gun barrel needs to be adjusted, the user drives the unlocking element 5 to move axially toward the side where the first tube body 1 is located so that the first annular protrusion 51 separates from the snap-fit elements 4, at this time, the elastic element 6 is in a compressed state, the snap-fit elements 4 are no longer constrained by the first annular protrusion 51, the snap-fit elements 4 are in a free or semi-constrained state, the snap-fit elements 4 are no longer locked in the snap-fit groove, and the second tube body 2 can move axially; by moving the second tube body 2, the length of the gun barrel can be adjusted, and when the gun barrel is adjusted to a suitable length and the snap-fit elements 4 fall into the corresponding snap-fit structure 201 of the second tube body 2, after the user releases the unlocking element 5, the elastic element 6 elastically recovers and drives the unlocking element 5 to reset to the state where the first annular protrusion 51 contacts the snap-fit elements 4, at this time, the snap-fit elements 4 are again locked in the snap-fit groove, the first tube body 1 and the second tube body 2 are stably connected, thus achieving simple and efficient length adjustment of the gun barrel.

In this embodiment, as shown in FIGS. 3 and 4, the outer peripheral wall of the connector 3 has a second annular protrusion 31, the second annular protrusion 31 is arranged around the axis of the connector 3, and the second annular protrusion 31 is located inside the unlocking element 5; an accommodating space is formed between the inner wall surface of the unlocking element 5, the first annular protrusion 51 and the second annular protrusion 31, the elastic element 6 is provided within the accommodating space, the two axial ends of the elastic element 6 along the connector 3 respectively contact the first annular protrusion 51 and the second annular protrusion 31, specifically, by accommodating the elastic element 6 in the accommodating space, the elastic element 6 can be stably positioned, and the gun barrel features a compact structure.

Furthermore, as shown in FIG. 3, the elastic element 6 is a spring, the spring is sleeved on the outer periphery of the connector 3, and the spring may be used as the elastic element 6 to offer a simple structure and convenient installation.

Furthermore, the connector 3 is threadedly connected to the connecting end, this structure achieves the connection between the connector 3 and the first tube body 1, featuring a simple structure, high connection stability, and convenient installation.

Furthermore, as shown in FIG. 1, the gun barrel further includes a valve 7 and a joint 8, along the axial direction of the first tube body 1, the valve 7 is connected to the other end of the first tube body 1 relative to the connecting end, and the joint 8 is connected to the end of the valve 7 away from the first tube body 1; taking the application of the gun barrel in a high-pressure water gun as an example for explanation, the joint 8 is used to connect to the water gun, the valve 7 is set on the gun barrel to facilitate user control over the opening and closing of the gun barrel, allowing users to flexibly start and stop cleaning operations, or adjust water flow as needed.

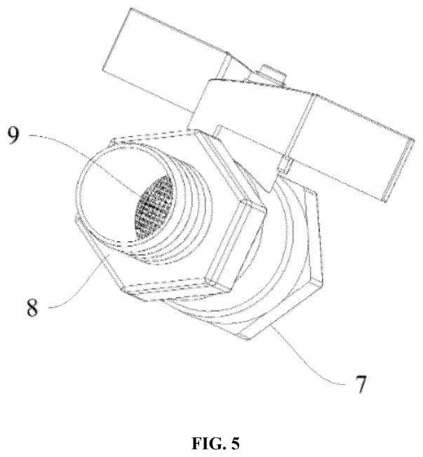

Furthermore, as shown in FIG. 5, the gun barrel further includes a filter screen 9, the filter screen 9 is provided inside the end of the valve 7 near the joint 8, the installation of the filter screen 9 can prevent impurities from entering the gun barrel, which could cause wear.

Furthermore, as shown in FIG. 1, the gun barrel further includes a nozzle 10, and along the axial direction of the second tube body 2, the nozzle 10 is connected to the end of the second tube body 2 away from the first tube body 1. The function of the nozzle 10 is to converge and accelerate the high-pressure water flow from the gun barrel to form a high-pressure jet, improving cleaning effectiveness; additionally, by changing the shape and internal structure of the nozzle 10, various water flow patterns can be produced, enabling the gun barrel to be suitable for cleaning operations in different scenarios.

Additionally, there may be a plurality of second tube bodies 2, and the plurality of second tube bodies 2 are sequentially inserted along the axial direction of the first tube body 1. The second tube body 2 closest to the first tube body 1 is connected to the connecting end, adjacent two second tube bodies 2 are connected through cooperation of the aforementioned connector 3, the snap-fit element 4 and the unlocking element 5, and the nozzle 10 is connected to the second tube body 2 farthest from the first tube body 1. Based on this, the gun barrel has a greater length adjustment range.

### According to Another Embodiment of the Present Disclosure

Regardless of the specific relationship between the outer diameter of the second tube body 2 and the inner diameter of the first tube body 1, and regardless of the specific form and quantity of the snap-fit structure 201, as long as the five basic components—the first tube body 1, the second tube body 2, the connector 3, the snap-fit element 4, and the unlocking element 5—are present, and the movement and fixation of the second tube body 2 are controlled through the separable contact between the unlocking element 5 and the snap-fit element 4, it falls within the scope of protection of the present disclosure.

Specifically, referring to FIGS. 1 to 5, the gun barrel of this embodiment includes a first tube body 1 and a second tube body 2. One end of the first tube body 1 is the connecting end, and the second tube body 2 is sealingly inserted into the first tube body 1 from this connecting end. The connector 3 is fixed to the connecting end, the snap-fit element 4 is connected to the connector 3, and the unlocking element 5 is movably connected to the connector 3. The unlocking element 5 maintains a separable contact relationship with the snap-fit element 4: when the two are in contact (typically the normal state), the unlocking element 5 imposes a constraint on the snap-fit element 4, enabling the snap-fit element 4 to tightly lock onto the corresponding structure on the outer wall of the second tube body 2 (such as the snap-fit structure 201 described later), thereby locking the second tube body 2 and preventing it from moving along its length direction; when length adjustment is required, operating to separate the unlocking element 5 from the snap-fit element 4 removes the aforementioned constraint, allowing the second tube body 2 to freely extend and retract along its length direction.

As a preferred and more specific implementation, the outer diameter of the second tube body 2 may be designed to be smaller than the inner diameter of the first tube body 1 to achieve smooth telescoping. Meanwhile, the snap-fit structure 201 may be provided on the outer wall surface of the second tube body 2 to offer clear snap-fit positioning points. Furthermore, there may be a plurality of snap-fit structures 201 arranged at intervals along the length direction of the second tube body 2, thereby achieving a plurality of fixed positions at different lengths.

Under this structure, the working principle of locking and unlocking is as follows: when the unlocking element 5 contacts the snap-fit element 4, it forces the snap-fit element 4 to move inward and be locked tightly onto one of the snap-fit structures 201, achieving reliable fixation. When the unlocking element 5 separates from the snap-fit element 4, the snap-fit element 4 loses external pressure and can move radially outward, thereby disengaging from the locked state with the snap-fit structure 201, allowing the second tube body 2 to be adjusted. A preferred form of the snap-fit structure 201 is a snap-fit groove that is annular and arranged around the axis of the second tube body 2; when paired with a spherical snap-fit element 4, it provides balanced circumferential constraint, preventing rotation of the second tube body 2 and offering better stability.

In this example, the cleaning device operates by outputting a cleaning medium (such as high-pressure water) through the gun barrel. The specific construction of its gun barrel can encompass the features of all the aforementioned embodiments;

Specifically, the gun barrel used in this cleaning device has an annular snap-fit groove on the outer wall of the second tube body 2, serving as the snap-fit structure 201. A plurality of spherical snap-fit elements 4 are accommodated in the accommodating through holes 301 distributed circumferentially on the tubular connector 3. The tubular unlocking element 5 is sleeved outside the connector 3; the first annular protrusion 51 on its inner wall, under normal conditions (via the preload of the elastic element 6), contacts all snap-fit elements 4, forcing them to engage into the snap-fit groove to achieve locking. When adjustment is needed, axially move the unlocking element 5 to separate its first annular protrusion 51 from the snap-fit elements 4, allowing the snap-fit elements 4 to disengage. After adjusting the second tube body 2 to the desired length, release the unlocking element 5, which resets under the action of the elastic element 6 and re-locks.

Preferably, as in claim 18, the outer wall of the connector 3 is provided with a second annular protrusion 31, which, together with the inner wall of the unlocking element 5 and the first annular protrusion 51, forms an accommodating space. The elastic element 6 (such as a spring) is placed in this space and sleeved on the connector 3, with its two ends respectively abutting against the first annular protrusion 51 and the second annular protrusion 31, resulting in a compact structure and reliable resetting.

Additionally, this gun barrel may be integrated with other functional components to form a complete operational module: the connecting end between the connector 3 and the first tube body 1 may adopt a threaded connection for easy assembly and maintenance. Along the axis of the first tube body 1, a valve 7 and a joint 8 can be sequentially connected at its other end. The valve 7 controls the on/off of the medium, and the joint 8 connects to the main unit of the cleaning device. A filter screen 9 can be installed inside the end of the valve 7 near the joint 8 to filter impurities and protect the interior of the gun barrel. A nozzle 10 can be installed at the end of the second tube body 2 to shape and guide the jet flow, enhancing cleaning effectiveness.

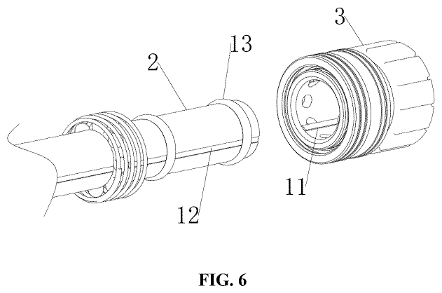

Furthermore, as shown in FIG. 6, by providing ribs 11 inside the connector 3 and setting vertical grooves 12 on the outer wall of the second tube body 2 that match the ribs 11, the ribs 11 are engaged into the vertical grooves 12 to achieve a positioning effect, preventing accidental rotation of the second tube body 2. Moreover, at least two sealing gaskets 13 are axially arranged on the outer wall of the second tube body 2. When the second tube body 2 is connected to the first tube body 1 via the connector 3, the sealing gaskets 13 is embedded into the connector 3, ensuring a seal at the connection.

In the description of the present disclosure, it should be understood that directional terms such as “front, back, upper, lower, left, right,” “transverse, vertical, perpendicular, horizontal,” and “top, bottom,” generally refer to the orientations or positional relationships shown in the accompanying drawings. They are used only for the convenience of describing the present disclosure and simplifying the description. Unless otherwise specified, these directional terms do not indicate or imply that the device or element referred to must have a specific orientation or be constructed and operated in a specific orientation, and therefore should not be construed as limiting the scope of protection of the present disclosure. The directional terms “inner, outer” refer to the inside and outside relative to the profile of each component itself.

For ease of description, spatial relative terms such as “on,” “above,” “upper surface,” “upper,” may be used herein to describe the spatial relationship of one device or feature to other devices or features as illustrated in the figures. It should be understood that the spatial relative terms are intended to encompass different orientations of the device in use or operation in addition to the orientation depicted in the figures. For example, if a device in the FIGS. is inverted, a device described as being “above” or “on” other devices or structures would then be oriented as “below” or “beneath” the other devices or structures. Thus, the exemplary term “above” can encompass both “above” and “below” orientations. The device may also be oriented in other ways (rotated 90 degrees or at other orientations), and the spatial relative descriptions used herein should be interpreted accordingly.

Furthermore, it should be noted that the use of terms such as “first”, “second” to define components is merely for the purpose of distinguishing the corresponding components, and unless otherwise stated, these terms do not have special meanings. Therefore, they should not be construed as limiting the scope of protection of the present disclosure.

The above descriptions are merely preferred embodiments of the present disclosure and are not intended to limit the present disclosure. For those skilled in the art, various modifications and changes can be made to the present disclosure. Any modification, equivalent substitution and improvement made within the spirit and principles of the present disclosure shall be included within the scope of protection of the present disclosure.

What is claimed is:

1. A gun barrel, comprising: a first tube body, a second tube body, a connector, a snap-fit element and an unlocking element;
wherein one end of the first tube body along a length direction thereof is a connecting end;
an outer diameter of the second tube body is smaller than an inner diameter of the first tube body, the second tube body is sealingly inserted into the first tube from the connecting end, an outer wall surface of the second tube body is provided with a plurality of snap-fit structures that are arranged at intervals along a length direction of the second tube body;
the connector is connected to the connecting end;
the snap-fit element is connected to the connector;
the unlocking element is connected to the connector and separably contacts the snap-fit element, allowing the snap-fit element to be locked onto one of the snap-fit structures; and
when the unlocking element is separated from the snap-fit element, the snap-fit element is allowed to disengage from a locked state with the snap-fit structure, and the second tube body is allowed to move along the length direction thereof.

2. The gun barrel according to claim 1, wherein the snap-fit structure is an annular snap-fit groove that is arranged around an axis of the second tube body.

3. The gun barrel according to claim 2, wherein the snap-fit element is spherical, and there are a plurality of snap-fit elements;
the connector is cylindrical, one end of the connector along a length direction thereof is fixedly connected to the connecting end, the connector is provided with a plurality of accommodating through holes that are arranged around an axis of the connector, and each accommodating through hole is movably connected with one snap-fit element;
the unlocking element is cylindrical and is sleeved on an outer periphery of the connector, an inner wall surface of the unlocking element has a first annular protrusion, the first annular protrusion is arranged around an axis of the unlocking element, and a side of the first annular protrusion facing the connector contacts all snap-fit elements, so that the snap-fit elements are locked in the snap-fit groove;
the gun barrel further comprises an elastic element, the elastic element is connected to the unlocking element and the connector, so that the first annular protrusion maintains contact with the snap-fit elements; and
wherein the unlocking element is capable of moving along a length direction thereof under the action of an external force, and when the unlocking element moves a preset distance, the first annular protrusion separates from the snap-fit elements, allowing the snap-fit elements to move and disengage from a locked state with the snap-fit groove.

4. The gun barrel according to claim 3, wherein an outer peripheral wall of the connector has a second annular protrusion, the second annular protrusion is arranged around the axis of the connector and located inside the unlocking element; and
an accommodating space is formed between the inner wall surface of the unlocking element, the first annular protrusion and the second annular protrusion, the elastic element is arranged within the accommodating space, with two ends thereof along an axial direction of the connector contacting the first annular protrusion and the second annular protrusion respectively.

5. The gun barrel according to claim 4, wherein the elastic element is a spring sleeved on the outer periphery of the connector.

6. The gun barrel according to claim 3, wherein the connector is threadedly connected to the connecting end.

7. The gun barrel according to claim 1, wherein the gun barrel further comprises a valve and a joint, the valve is connected to the other end of the first tube body relative to the connecting end along an axial direction of the first tube body, and the joint is connected to an end of the valve away from the first tube body.

8. The gun barrel according to claim 7, wherein the gun barrel further comprises a filter screen, and the filter screen is arranged inside an end of the valve adjacent to the joint.

9. The gun barrel according to claim 1, wherein the gun barrel further comprises a nozzle, and the nozzle is connected to an end of the second tube body away from the first tube body along an axial direction of the second tube body.

10. A gun barrel, comprising: a first tube body, a second tube body, a connector, a snap-fit element and an unlocking element;
wherein one end of the first tube body along a length direction thereof is a connecting end;
the second tube body is sealingly inserted into the first tube from the connecting end;
the connector is connected to the connecting end;
the snap-fit element is connected to the connector; and
the unlocking element is connected to the connector and separably contacts the snap-fit element, allowing the second tube body to move along a length direction thereof.

11. The gun barrel according to claim 10, wherein an outer diameter of the second tube body is smaller than an inner diameter of the first tube body.

12. The gun barrel according to claim 10, wherein an outer wall surface of the second tube body is provided with a snap-fit structure.

13. The gun barrel according to claim 12, wherein there are a plurality of snap-fit structures, and the plurality of snap-fit structures are arranged at intervals along the length direction of the second tube body.

14. The gun barrel according to claim 13, wherein when the unlocking element contacts the snap-fit element, the snap-fit element is allowed to be locked onto one of the snap-fit structures; and
when the unlocking element is separated from the snap-fit element, the snap-fit element is allowed to disengage from a locked state with the snap-fit structure.

15. The gun barrel according to claim 14, wherein the snap-fit structure is an annular snap-fit groove that is arranged around an axis of the second tube body.

16. A cleaning device, comprising: a gun barrel, wherein the gun barrel comprises a first tube body, a second tube body, a connector, a snap-fit element and an unlocking element;
one end of the first tube body along a length direction thereof is a connecting end;
an outer wall surface of the second tube body is provided with a snap-fit structure;
one end of the connector along a length direction thereof is fixedly connected to the connecting end;
the snap-fit element is arranged on the unlocking element; and
the unlocking element is sleeved on an outer periphery of the connector.

17. The cleaning device according to claim 16, wherein:
the snap-fit structure is an annular snap-fit groove that is arranged around an axis of the second tube body;
the snap-fit element is spherical, and there are a plurality of snap-fit elements;
the connector is tubular and is provided with a plurality of accommodating through holes, the plurality of accommodating through holes are arranged around an axis of the connector, and each accommodating through hole is movably connected with one snap-fit element;
the unlocking element is tubular, an inner wall surface of the unlocking element has a first annular protrusion, the first annular protrusion is arranged around an axis of the unlocking element, and a side of the first annular protrusion facing the connector contacts all snap-fit elements, so that the snap-fit elements are locked into the snap-fit groove;
the gun barrel further comprises an elastic element, and the elastic element is connected to the unlocking element and the connector, so that the first annular protrusion maintains contact with the snap-fit elements; and
wherein the unlocking element is capable of moving along a length direction thereof under the action of an external force, and when the unlocking element moves a preset distance, the first annular protrusion separates from the snap-fit elements, allowing the snap-fit elements to move and disengage from a locked state with the snap-fit groove.

18. The cleaning device according to claim 17, wherein an outer peripheral wall of the connector has a second annular protrusion, the second annular protrusion is arranged around the axis of the connector and located inside the unlocking element; and
an accommodating space is formed between the inner wall surface of the unlocking element, the first annular protrusion and the second annular protrusion, the elastic element is arranged within the accommodating space, with two ends thereof along an axial direction of the connector contacting the first annular protrusion and the second annular protrusion respectively.

19. The cleaning device according to claim 18, wherein the elastic element is a spring, and the spring is sleeved on the outer periphery of the connector.

20. The cleaning device according to claim 17, wherein the connector is threadedly connected to the connecting end;
the gun barrel further comprises a valve and a joint, the valve is connected to the other end of the first tube body relative to the connecting end along an axial direction of the first tube body, and the joint is connected to an end of the valve away from the first tube body;
the gun barrel further comprises a filter screen that is arranged inside an end of the valve adjacent to the joint; and
the gun barrel further comprises a nozzle, and the nozzle is connected to an end of the second tube body away from the first tube bod along an axial direction of the second tube body.
